(19) United States
(12) Patent Application Publication
(10) Pub. No.: US 2004/0005085 A1
(43) Pub. Date: Jan. 8, 2004

(54) Method of aerial monitoring of forests

(76) Inventor: Dan Keith Andersen, Red Deer (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/289,474

(22) Filed: Nov. 6, 2002

(30) Foreign Application Priority Data
Jul. 4, 2002 (CA) 2,392,410

(51) Int. Cl. G06K 9/00

(52) U.S. Cl. 382/109

(57) ABSTRACT

A method of aerial monitoring of forests. The method includes a step of examining a forest from above with a camera capable of capturing a thermal image. The camera has a resolution of at least 460×460 pixels. The purpose of the monitoring is to determine reflective qualities of trees in the forest, such reflective qualities being indicative of moisture content.

### FIELD OF THE INVENTION

The present invention relates to a method of aerial monitoring of forests

### BACKGROUND OF THE INVENTION

At the present time the aerial monitoring of forests is primarily reactive. For example, when fire hazards are extreme forestry personnel will fly over forests in helicopters looking for fire.

### SUMMARY OF THE INVENTION

What is required is a more proactive method of aerial monitoring of forests.

Tests were conducted attempting to find a method of aerial monitoring of forests which would identify conditions conducive to fire, before a fire actually occurred. It was felt that with sufficient early warning, measures could be taken to ameliorate the conditions and, thereby, avoid a fire loss. Selected groups of trees in a forest area were watered so that their moisture content differed from the remainder of the trees. These trees were given four litres of water each. The moisture content of trees in the forest was then examined from a helicopter using thermal imaging. At a resolution of 256×256 pixels the difference in the moisture content of the trees was not detectable with thermal imaging. The resolution was then incrementally increased until, at a resolution of 460×460 pixels, thermal imaging was able to accurately pick out those trees that had been watered due to their lower reflective quality. As tests were expanded to areas of the forest not manually watered, it was discovered that rain patterns unevenly distributed moisture in the forest. Some areas of the forest were found to be in a “rain shadow” due to surrounding topography and received less rainfall. The tests indicated that the proactive use of thermal imaging could be used as an accurate predictor of moisture content which is one of the conditions conducive to fire.

According to the present invention there is provided a method of aerial monitoring of forests. The method includes a step of examining a forest from above with a camera capable of capturing a thermal image. The camera has a resolution of at least 460×460 pixels. The purpose of the monitoring is to determine reflective qualities of trees in the forest, such reflective qualities being indicative of moisture content.

With accurate information regarding moisture content, the forestry service can identify areas of the forest which are so dry that the conditions are conducive to fire. The forestry service can then take measures to prevent a fire occurring or contain a fire should it occur. The preventative measures may consist of watering areas of the forest, clearing of the forest of deadfall and brush that would fuel a fire, or bulldozing earthen fire barriers.

Although beneficial results may be obtained through the use of the method, as described above, there are other conditions in the forest which warrant proactive monitoring and preventative action. For example, there may be some areas in which erosion is of concern and other areas in which weed control is of concern and yet other areas in which the health of the trees due to disease is of concern. Or it may merely be a matter of monitoring the pigmentation, foliage and growth of a healthy forest. Even more beneficial results may, therefore, be obtained when the camera used is a dual sensor camera having both a thermal image sensor capable of capturing a thermal image and a daylight image sensor capable of capturing a daylight image. With such a dual sensor camera the forestry service can contemporaneously take the thermal image and the daylight image. It is preferred that the daylight image have 700 lines of resolution.

Although it is envisaged that the aerial monitoring described above will be conducted by helicopter, it is possible that this technology may be used as part of an unmanned tower lookout system. Furthermore, as technology improves it may be possible to do the aerial monitoring described above by airplane or even by satellite. At the present time a helicopter is more practical due to constraints relating to camera range and the speed that video pictures can be taken during flight.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of an aircraft monitoring a utility line in accordance with the teachings of the present invention.

FIG. 2 is a schematic view of equipment configured in accordance with the teachings of the present method.

### DETAILED DESCRIPTION OF THE PREFERRED EMBODIMENT

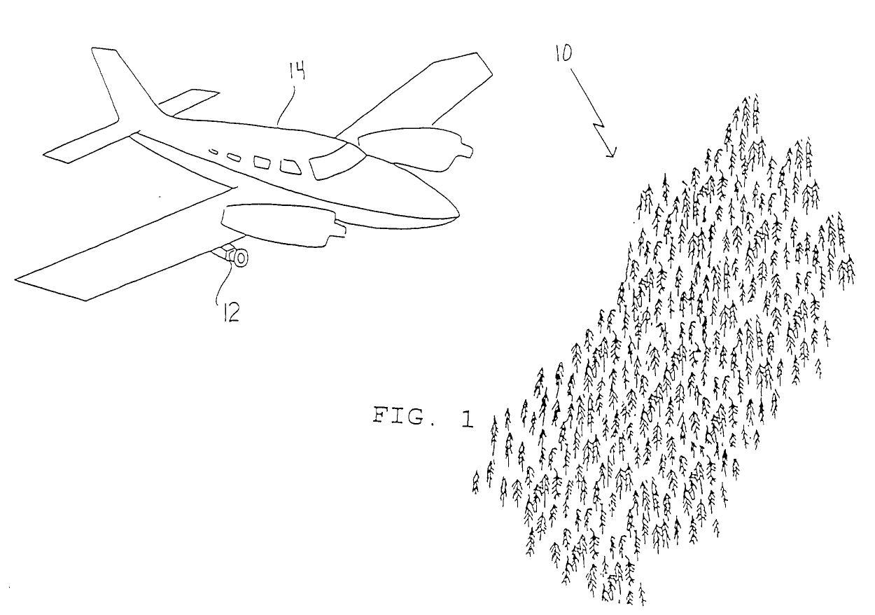

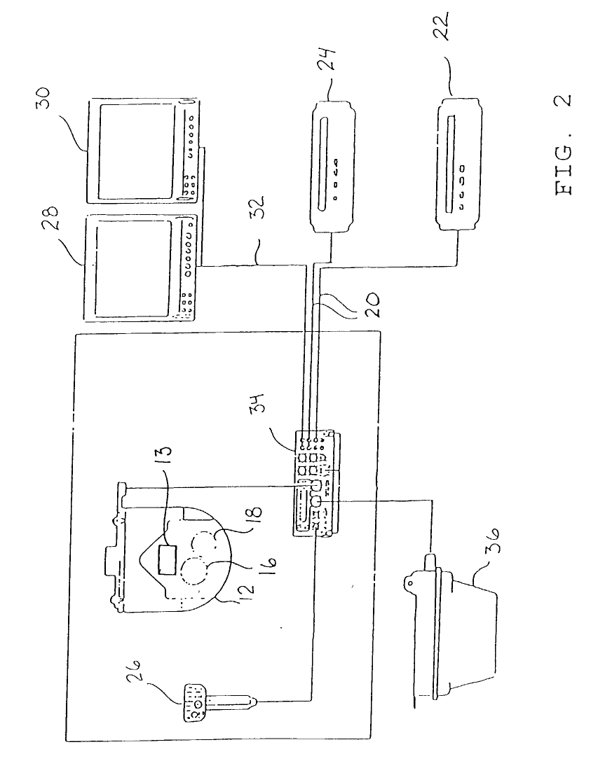

The preferred method of aerial monitoring of forests will now be described with reference to FIGS. 1 and 2.

Referring to FIG. 1 there is provided a method of aerial monitoring of forests 10 which involves examining a forest 10 from above with a camera 12 that capable of capturing a thermal image. Camera 12 has a resolution of at least 460×460 pixels, to determine reflective qualities of trees in forest 10, said reflective qualities being indicative of moisture content. Referring to FIG. 2, in the illustrated embodiment, camera 12 is a dual sensor camera which has both a thermal image sensor 16 capable of capturing a thermal image and a daylight image sensor 18 capable of capturing a daylight image, such that the camera 12 contemporaneously takes the thermal image and the daylight image. Camera 12 has a daylight image resolution of greater than 700 lines. In the illustrated embodiment, a global positioning system (GPS) 13 is incorporated with camera 12. Referring to FIG. 1, with aerial monitoring of forests 14, conditions conducive to fire can be identified before a fire actually occurred by viewing the thermal image. By viewing the daylight image, areas in which erosion, weed control, and health of the trees due to disease is of concern or in which pigmentation, foliage and growth of a healthy forest 10 are of a concern can be evaluated. Global positioning system 13 helps to precisely identify the coordinates of the physical location where the thermal image and daylight image are captured by camera 12.

Referring to FIG. 1, in the illustrated embodiment, aerial monitoring of forest 10 is accomplished by mounting dual sensor camera 12 on airplane 14. It will be appreciated that aerial monitoring could also be accomplished from an unmanned lookout tower, a helicopter or satellite as well. Where airplane 14 is used, airplane 14 is flown above forest 10, such that dual sensor camera 12 is able to simultaneously capture the thermal image and the daylight image.

Referring to FIG. 2, in the illustrated embodiment, the thermal and daylight images are communicated via input cables 20 to first video tape recorder 22 and second video tape recorder 24. It will be appreciated that other types of known recording medium suited for the aviation industry, such as digital recorders, can also be used to store the thermal images and the video images for subsequent viewing. The functions of dual sensor camera 12 can be controlled through hand controller 26. A first monitor 28 is provided through which the thermal image can displayed. Thermal image displayed on first monitor 28 can be overlapped with information from global positioning system 13. A second monitor 30 is also provided on which the daylight image can be displayed. Daylight image that is displayed on second monitor 30 can also be overlapped with information from global positioning system 13. First monitor 28 and second monitor 30 receive images via cable 32. It is envisaged that an on board interface unit 34 will be provided through which the various components of the system are controlled. In addition, all data can be sent by to ground based personnel via a microwave transmitter 36.

In the process of proving the invention, experiments were conducted relating to altitude, flight speed and camera zoom ratios. It was determined that an altitude of approximately 150 feet ideal vegetation was preferred. Beneficial results were still obtained when operating within a range of 150 feet to 300 feet. At altitudes over 300 feet, resolution was lost. It was determined that a speed of less then 40 nautical miles per hour was preferred. Beneficial results were still obtained when operating within a range of 40 to 70 miles per hour. At speeds in excess of 70 miles per hour, resolution was lost. It was determined that an optical zoom ratio of 14 to 1 or greater was preferred. Beneficial results were still obtained when operating with a zoom ratio of less then 14 to 1 down to 7 to 1. With zoom ratios of less than 7 to 1, resolution was lost. It was determined that 700 lines of daytime resolution was preferred. Beneficial results were still obtained within a range of 700 lines of resolution down to 440 lines of resolution. Below 440 lines of resolution there was inadequate resolution for an accurate assessment of vegetation strength.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. A method of aerial monitoring of forests, comprising the step of:
examining a forest from above with a camera capable of capturing a thermal image, the camera having a resolution of at least 460×460 pixels, to determine reflective qualities of trees in the forest, said reflective qualities being indicative of moisture content.

2. The method as defined in claim 1, the camera being a dual sensor camera having both a thermal image sensor capable of capturing a thermal image and a daylight image sensor capable of capturing a daylight image, such that the camera contemporaneously takes the thermal image and the daylight image.

3. The method as defined in claim 2, the camera having a daylight image resolution of greater than 440 lines.

4. The method as defined in claim 3, the camera having a daylight image resolution of greater than 700 lines.

5. The method as defined in claim 1, the flight speed being less than 70 nautical miles per hour.

6. The method as defined in claim 5, the flight speed being less than 40 nautical miles per hour.

7. The method as defined in claim 1, the flight altitude being less than 300 feet from vegetation.

8. The method as defined in claim 7, the flight altitude being less than 150 feet from vegetation.

9. The method as defined in claim 1, an optical zoom ratio of at least 7 to 1 being used.

10. The method as defined in claim 9, an optical zoom ratio of at least 14 to 1 being used.

11. A method of aerial monitoring of forests, comprising the step of:
examining a forest from above with a camera capable of capturing a thermal image, the camera having a resolution of at least 460×460 pixels, to determine reflective qualities of trees in the forest, said reflective qualities being indicative of moisture content, the camera having a daylight image resolution of greater than 440 lines, the flight speed being less than 70 nautical miles per hour, the flight altitude being less than 300 feet from vegetation, and an optical zoom ratio of at least 7 to 1 being used.

12. The method as defined in claim 11, the camera being a dual sensor camera having both a thermal image sensor capable of capturing a thermal image and a daylight image sensor capable of capturing a daylight image, such that the camera contemporaneously takes the thermal image and the daylight image.

13. The method as defined in claim 11, the camera having a daylight image resolution of greater than 700 lines.

14. The method as defined in claim 11, the flight speed being less than 40 nautical miles per hour.

15. The method as defined in claim 11, the flight altitude being less than 150 feet from vegetation.

16. The method as defined in claim 11, an optical zoom ratio of at least 14 to 1 being used.
